(19) United States
(12) Patent Application Publication
(10) Pub. No.: US 2024/0052279 A1
(43) Pub. Date: Feb. 15, 2024

(54) FLAVORING FOR SPIRITS AND WINE AND METHODS FOR MAKING AND INFUSING

(71) Applicant: COOPERAGES 1912, LLC, Lebanon, MO (US)

(72) Inventors: LAWRENCE WU, JR., BURIEN, WA (US); STEVE DORFMAN, RENO, NV (US)

(73) Assignee: COOPERAGES 1912, LLC, Lebanon, MO (US)

(21) Appl. No.: 18/231,889

(22) Filed: Aug. 9, 2023

Related U.S. Application Data
(60) Provisional application No. 63/397,956, filed on Aug. 15, 2022.

(51) Int. Cl. C12G 3/07; C12G 1/00

(52) U.S. Cl. CPC C12G 3/07; C12G 1/00; C12G 2200/21

(57) ABSTRACT

A method of generating flavorings and infusing flavors into wines and spirits. The flavoring is generated by selection a wood or plant suitable for micronizing, selecting a micronization size, and micronizing the wood or plants so that most of the wood or plants are broken at weak structural locations such as cell walls or other boundary areas. The micronized wood or plant product is added to wine or distillates for a length of time based on the dosing on a table of expected results. In another embodiment, the length of time is based on testing the wine or distillates.

### CROSS-REFERENCE TO RELATED APPLICATIONS

This application claims the benefit and priority of the U.S. Provisional Application Ser. No. 63/397,956, filed on Aug. 15, 2022, entitled “METHOD FOR MAKING WOOD FLAVORING AND IMPARTING FLAVORING TO SPIRITS AND WINE” all of which is incorporated by reference herein in its entirety, including all references and appendices, for all purposes.

### FIELD OF THE INVENTION

The invention relates to the field of methods and techniques for imparting or infusing flavors and/or color into spirits, wines, or other drinks.

### BACKGROUND OF THE INVENTION

Wood, specifically Oak woods (Quercus alba, Quercus petraea) have long been used as liquid storage containers (since 300 B.C.) Due to the way Quercus sp. grows, the grain in the wood creates radial rays (lignin layers) that prevent liquid permeability. This allows for the construction of casks and barrels from Oak that can securely hold liquid without leaking. The science of using Oak to purposely enhance the sensory properties of the product stored in those barrels is a more modern (less than 600 years) science. Over the last two centuries, the knowledge and the controlled application of that knowledge have dramatically increased and vastly improved the quality of wines, fortified wines, and wood-aged spirits. And even more recently, the discovery that the addition of heat to toast and char the inside of the Oak barrel to functionally alter the wood and greatly improve the flavor and color of liquids stored in those heat-treated barrels has fundamentally created new and iconic products for the wine and spirits industry. The sensory improvement of using Oak is species specific. French Oak (Quercus petraea), grown in Western Europe, is much tighter-grained and less dense than the American Oak (Quercus alba) and imparts more subtle flavors; fruity, cinnamon, and allspice along with chocolate, smoky, and coffee when heat has been applied to the barrel. American Oak, grown in the midwestern part of the U.S., tends to impart stronger and sweeter aromas and flavors including vanilla, caramel, coconut, and clove. Winemakers and Master Distillers still use toasted and charred Oak barrels today to impart flavor and structure (the complex relationship between tannins and acidity) to wines and spirits. The combination of structure and flavor generation has kept this ages-old tradition unchanged into present times; safe storage of valuable liquids with enhanced quality over time is still a great combination for making desirable potent potables.

Winemakers have known for decades that the Oak barrel is not a necessity to add the benefits of Oak to their products. “Tank Aging” the wine in a stainless-steel tank loaded with Oak staves, fans, cubes, or chips can achieve the same effect as if stored in an Oak barrel. The process can be shortened by increasing the use of smaller pieces of Oak. So, by decreasing the size of the Oak particles and increasing the surface area of the wood, the benefits of barrel aging can be replicated in a shorter amount of time without the use of the barrel. The industry of Oak Complements was born from that knowledge. However, it is also generally known that the smaller the piece of wood, the harder it is to control over-extraction of the wood, leading to astringent and tannin imbalance, whether it is smaller barrels or smaller chips, as the size of the wood is reduced and the surface area-to-weight ratio increases, so does the increase in astringency and over-extraction from the smaller wood particles or barrels.

Using barrels to age and mature wines, fortified wines, and spirits has both plusses and minuses. On the plus side, barrels are both a stout storage vessel and have the ability to impart flavor, color, and structure to the stored liquids. The barrels are sturdy and easy to store and move, and the volumes have been standardized globally. Used barrels can be reused many times, with the used barrel market itself a $5-600 Million business annually. On the minus side, it is hard to predict barrel maturation since it is affected by environmental conditions outside of industrial control. After a barrel's life is used up, there is a cost to the disposal of used barrels.

The barrels are costly to manufacture since each barrel is handmade. The cooperage costs are magnified when the factor of waste is taken into consideration. A single, mature Oak tree might only provide enough wood to make just two 53-gallon barrels. The remaining trimmed wood cannot be made into barrels and is considered a waste stream. That waste is directly a result of how a barrel must be made in order to be watertight. To make a standard watertight barrel, the cooperage must use directional milling to ensure that the lignin-based radial rays are aligned properly within the staves to prevent seeping and leakage. Specifically, the radial rays should overlap like roof shingles when viewed cross-sectionally on each stave end. This leads barrel producers to reject the overwhelming majority of wood from the harvested Oak. This practice is neither practical nor ecologically sustainable. The invention described here demonstrates a new, novel approach taken to allow for the historical wood-maturation of wines, fortified wines, and spirits, while improving the speed and control at which maturation is completed.

Oak is becoming increasingly expensive and has a negative environmental impact resulting from cutting down trees. Additionally, the time required for wood maceration is considerable. It can take years of barrel aging to obtain the desired flavor and color of the wine or spirit. Holding a product for such an extended time is expensive for the producer and adds cost to the consumer. What is needed is a more efficient, cost effective, and timely way to infuse flavors from oak and other plants into wines, whiskeys, and other spirits.

### SUMMARY

In one embodiment, a method of generating flavoring is provided. First one or more woods that have the desired flavor profile is selected. Next, the micronization size is selected. The micronization size can be selected from a table that provides an previously measured taste profile. Next the wood or woods are micronized using a process that creates particles by minimizing the breakage at cell walls and preferably between cells. French oak or American oak are commonly used but other woods such as cherry can be used.

In another aspect of the invention, a method of infusing flavors into spirits or wine is disclosed. A quantity of one or more micronized wood products based on a target taste profile is selected. The quantity selected is based on the amount of spirits or wine to be infused and how fast the infusion is to happen. A period of time is waited for the infusion of the flavors. The infusion time can also be based on color, testing of the infusion product for levels of one or more chemicals, or taste. After the infusion, the micronized wood product is filtered out from the spirits or wine.

In another aspect of the invention is a product by process. The product is produced by micronizing one or more woods to a size between two and fifty microns. The wood can include French and American Oak.

### BRIEF DESCRIPTION OF THE DRAWINGS

FIG. 1A—A table of the color of a distillate over time with two different dosing levels of micronized American Oak with a medium toast.

FIG. 1B—Chart showing the color of a distillate over time with two different dosing levels of micronized American Oak with a medium toast.

FIG. 2A—A table of oak volatiles within a distillate over an eleven-week infusion time with less than 50 micron micronized American Oak.

FIG. 2B—Chart showing the oak volatiles within a distillate over an eleven-week infusion time with less than 50 micron micronized American Oak.

FIG. 3A—A table of volatiles associated with astringency for a rum distillate infused for five weeks.

FIG. 3B—A bar chart of the Furfural Ethyl Ether volatile for a rum distillate infused for five weeks.

FIG. 3C—A bar chart of the 2,6-Duchlorophenol volatile for a rum distillate infused for five weeks.

FIG. 4—A flowchart for infusing micronized wood flavoring and colors into wines and spirits.

### DETAILED DESCRIPTION

The following detailed description includes references to the accompanying drawings, which are a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, functional, logical, and electrical changes can be made without departing from the scope of what is claimed. The following detailed description is, therefore, not to be taken in a limiting sense, and the scope is defined by the appended claims and their equivalents.

In one embodiment, the invention presented uses the stream of waste product from traditional Oak harvesting and milling to create a line of highly value-added and technically superior Oak products for the maturation of wine, fortified wine, and traditionally barrel-aged spirits industries. The rejected parts of harvested Oak of both species can be toasted and then processed in a specific method that, 1) reduces the physical size of the wood, 2) to exponentially increase the surface area-to-weight ratio, which 3) increases both the extraction and reaction rate of key desirable maturation compounds when in the presence of Ethanol, Oxygen, and the toasted wood.

The invention is novel in that the measurable size reduction is achieved without using any physical grinding, chipping, milling, crushing, rolling, etc. equipment or methods normally employed in reducing particle size. Without physical contact, there is no heat from friction created, and there isn't total destruction of cell matrices. The particle size of the wood is reduced using forces of inelasticity of the product itself. The product cannot withstand certain forces that are applied and is broken at weak structural locations such as cell walls or other boundary areas. That results in the retention of whole and entire cell structures in the wood. The equipment and method enables the micronization of the toasted Oak down to less than 50 microns in diameter (2-48μ) for example. For the purpose of this patent, the term micronization or micronized refers to a product made by the above described process and not by griding wood which breaks cellular walls.

One method for micronization of wood that minimizes the destruction of cell matrices and results in the substantial retention of whole with cell walls or other boundary areas is described by the PCT/EP2020/067040, Publication No. 2020/254538 A2, published 24 Dec. 2020, entitled LIBRIXER COMMINUTOR AND PARTICLE AIR CLASSIFIER SYSTEM.

The invention is novel in that specific size brackets of the micronized toasted Oak exhibit different sensory characteristics during the maturation of wine, fortified wine, or wood-aged spirit products. Using industry recognized methods for reducing wood particle sizes, undesirable sensory characteristics, namely wood astringency (tannins) typically develop over time. The imbalance in the resulting product's structure is notable and is considered a defect in sensory ratings. This defect is not observed when using the novel method of reducing particle size through inelasticity also referred to as micronization. In the under 50-micron micronized particle size (2-48μ), there is little extracted astringency in either Oak species. Astringency returns as particle size increases. This is also novel as it enables winemakers and master distillers control of the wood-extracted astringency by particle size.

The development of wood-matured flavor has not and will not change. It is still a mystical dance between the heat treated wood, the alcohol in the liquid, the oxygen in the air, and time. The invention presented is simply a new method for optimizing those natural reactions, improving the resulting quality of the finished product, while reducing the number of old-growth Oaks to be harvested.

As stated in the description, Oak woods have historically been used for the long-term storage and shipment of spirit beverages. The toasting and charring of White and French Oak barrels to generate flavor and color while storing and aging spirits is a more recent discovery and has lead to the development of all the major global whiskies: Bourbon, Rye, Scotch, Irish, Canadian, and Japanese. But barrel use and re-use to generate flavors and colors is not limited to whiskies, but also to other spirits: Brandy, Tequila, Rum, and Gin. The key ratio of “surface area to volume” (SAV) of liquid is key to controlling and managing color and maturation level of the spirit in a new barrel. Distillers have been experimenting for decades on how to increase this ratio. The standard whiskey barrel is 53 wine gallons and has an inside surface area of 3000 sq. Inches, so the ratio is 56.6 sq inches/gallon. A half-size barrel of 26 gallons has an inside surface area of about 1900 sq. Inches and the ratio is calculated to be 73.1 sq inches/gallon.

Anecdotally, half-size barrels are noted to age about 30% faster than their 53 gallon counterparts. This is not disputed in the industry. However, the chance of over-extracting or over-maturing your spirit increases when smaller barrels are used. Increasing the surface area to volume ratio should allow spirits to age more rapidly. The wood complements industry has attempted to decrease the size of the toasted wood to increase the rate of spirits maturity. Using conventional methods of chipping and milling toasted oak, the color and flavor generation can be sped up, but introduces increased extracted astringency. This has led to the abandonment of using chips or smaller wood pieces for maturation of spirits.

The invention presented claims to create smaller toasted oak particles for increased surface area to volume ratios without increasing the level of extracted astringency associated with chipped or ground toasted oak. The methodology employed in micronizing toasted oak yields particle sizes below 50-microns without perceived nor measured astringency upon extraction in water, alcohol, or a blend of water and alcohol. This is the critical particle size threshold for the micronizing method.

Conventional grinding to below 50-microns does not achieve the same result. Astringency of micro ground oak using conventional hammer milling is perceived as introducing unacceptable in levels of extracted astringency. The invention claims that the surface area equivalent to a toasted and charred fifty-three gallon White Oak barrel is achieved with 4-7 grams of micronized oak (depending on toast level and woodspecies). While the ratio of surface area to volume remains the same as a fifty-three gallon barrel, increasing the use level of the micronized oak multiplies the surface area to volume ratio and thereby decreases the maturation time of the spirit. For example, if a pound of micronized toasted oak is used to age fifty-three gallons of new whiskey distillate, it should age sixty-five times faster than a barrel of the same toast level (454 grams/lb/7 grams/barrel equiv.) If a barrel of bourbon normally takes four years to mature, then the bourbon aged with one pound of micronized oak would only take 22.5 days to reach the same level of color and flavor as conventional barrel-aged bourbon ((365 days/year×4 years)/65 SAV), and more importantly, without the unacceptable level of astringency normally associated with smaller wood particles. The invention claims that utilizing the described micronizing method explained in the invention results in not only small toasted oak particles of minute size (under 50μ) but leads to color extraction and flavor generation without the astringency normally associated with the micro grinding of wood. Positive maturation results are only achieved when the toasted oak is micronized utilizing the described methodology. Note, that woods other than oak, cherry for example, may exhibit desirable flavor characteristics when micronized at different particle sizes than oak. Further, the time required for infusion may be longer or shorter than for oak wood. Thus, the use of more than one wood species may utilize micronized wood species of different sizes and for different lengths of time.

### Astringency

The quantitative measure of astringency is difficult to achieve and is normally qualitatively organoleptic measurement. The drying condition of the mouth during organoleptic evaluation is noted and compared to reference samples. To make a claim, the development of a Gas Chromatography and Mass Spectrum analytical method was needed. The 3rd party lab used 3 samples: 1) an unaged rum distillate of Puerto Rican manufacture, 2) a sample aged on Micronized Oak of Medium toast level at <50μ size and 3) Medium toasted Oak that was ground conventionally through a hammer mill to a size of <50μ as well. Both samples of Oak were from the same toast lot, just milled differently. The Micronized sample was milled utilizing the technology described in the invention and is a key claim to the novelty of the invention. Identifying key compounds as markers for astringency was also critical. The 3rd party lab specialist identified two key compounds as the markers for astringency:
1. Furfural Ethyl Ether (CAS 6270-56-0)
2. 2,6-Dichlorophenol (CAS 87-65-0)

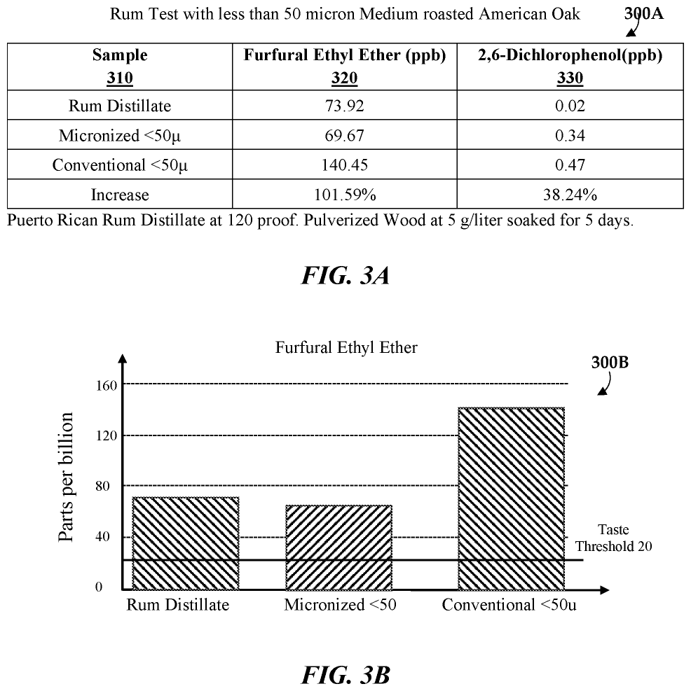

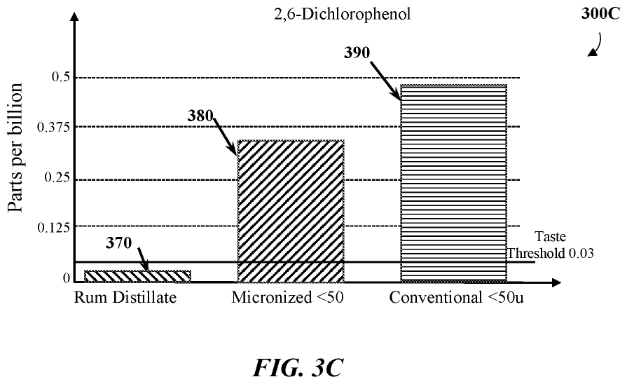

In FIGS. 3A, 3B, and 3C show both of these markers with a resulting in a 102% and 38% respectively increased with conventionally ground wood sample when compared to the micronized sample of the identical toasted oak. The low threshold for taste receptivity means these that in the conventionally ground sample of toasted oak, the Furfural Ethyl Ether is 7 times higher than the taste threshold, and the 2,6-Dichlorophenol is 16 times higher than the taste threshold of that compound. Each are described as both pungent and astringent to the taste receptors. In addition to the organoleptic difference in astringency noticed between the samples, key compound markers for astringency have been quantitatively identified in the samples.

The use of micronization of wood enables the faster maturation of spirits through the use of micronized toasted oak to increase the reactive surface area of the wood which increases the color and flavor generation in wood aged spirits without increasing the extracted astringency expected in smaller pieces of toasted oak.

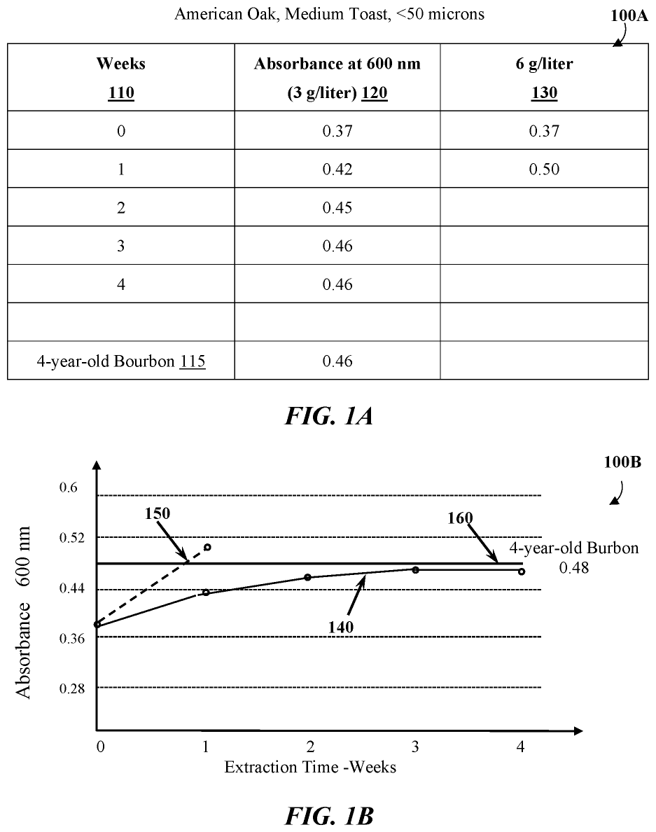

FIG. 1A shows the test results in a table 100A of infusing 50-micron micronized American Oak into a distillate for generating a spirit with similar characteristics as 4-year-old Bourbon. While this test result is based on color which is strongly correlated to flavor, further tables below show the test results measuring flavor and astringency related chemicals. The table 100A shows the absorbance of 600 nano meter light over four weeks. Absorbance of light relates to color which can be analogous to flavor. The first column 110 is the number of weeks that the micronized American Oak was left infusing into the distillate. The second column 120 and third column 130 is the 600 nano meter light absorption at the different weeks when the distillate is dosed with 3 grams per liter and 6 grams per liter. The reference value 115 for 4-year old Bourbon is provided at the bottom of the chart.

Of note are the two major benefits of using micronized wood. The color profile comparable to 4-year barrel aged bourbon 115 is achieved in approximately three weeks for the 3 g/liter of less than fifty microns micronized oak. For 6 g/liter, the bourbon comparable is achieve in under one week. This compares with the traditional method of aging in an oak barrel for years to reach the same color profile. Further, the amount of material required is significantly less than a barrel. One pound of micronized oak will treat 151 liters of distillates or nearly 40 gallons of distillates. An oak barrel weighs around 90 pounds of which 70-80 pounds is oak wood. Thus, micronized oak requires an order of magnitude less oak than using a barrel. While a barrel can be reused multiple times, there is still a significant savings of material.

FIG. 1B shows a graph of the information in the table shown in FIG. 1A. The curve 140 for the 3 g/liter dosing and the curve 150 is for the 6 g/liter dosing. A reference line 160 for 4-year-old bourbon.

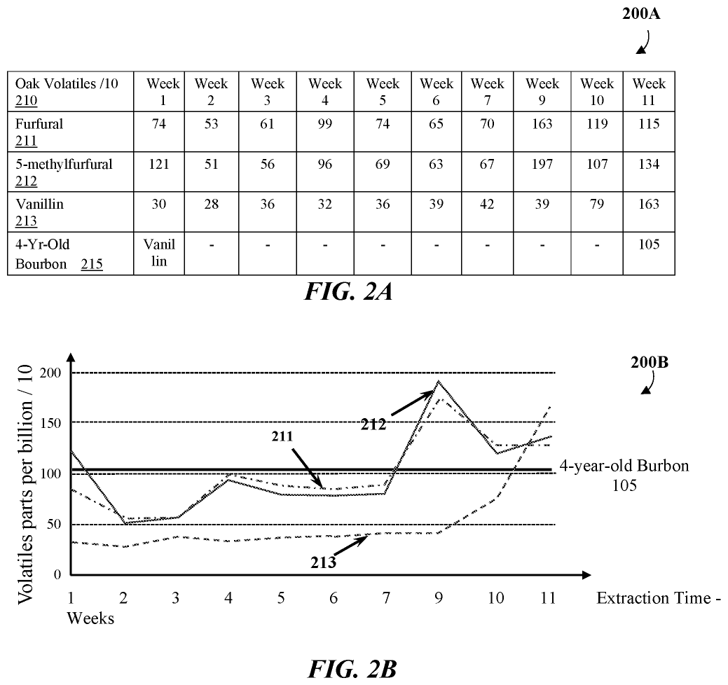

Referring to FIG. 2A, is a table 200A of the measured Oak volatiles 211, 212, and 213 over a eleven week maturation 210. The measured volatiles 210 includes furfural 211, 5-methylfurfural 212, and vanillin 213. The Vanillin 213 value is compared against 4-year-old Bourbon 215 as a reference value. Note, the scale of measured values are in parts per billion divided by a factor of ten.

Referring to FIG. 2B, is a graph 200B of the table in FIG. 2A. The graph shows the measured levels of furfural 211, 5-methylfurfural 212, and vanillin 213 over a eleven weeks. Note, no measurement was taken at week eight.

Referring to FIG. 3A, a table 300A of two chemicals that are associated with the astringency of a spirit. These chemicals are Furfural Ethyl Ether 320 and 2,6-Dichlorophenol 330. A 120 proof Puerto Rican Rum Distillate is used as a reference for these to chemicals. Note, the scale of measured values is in parts per billion.

Referring to FIG. 3B, is a bar graph 300B of the chemical Furfural Ethyl Ether from the table in FIG. 3A. The graph shows the measured levels of Furfural Ethyl Ether for the Puerto Rican Rum baseline, using micronized oak at five grams per liter soaked for five days, and the use of ground oak using the conventional means to grind. Note that the use of less than 50-micron micronized Oak has less of this chemical than the baseline Puerto Rican Rum.

Referring to FIG. 3C, is a bar graph 300C of the chemical and 2,6-Dichlorophenol from the table in FIG. 3A. The graph shows the measured levels of and 2,6-Dichlorophenol for the Puerto Rican Rum baseline, using micronized oak at five grams per liter soaked for five days, and the use of ground oak using the conventional means to grind. Note that the use of less than 50-micron micronized Oak has less of this chemical than the conventionally ground wood.

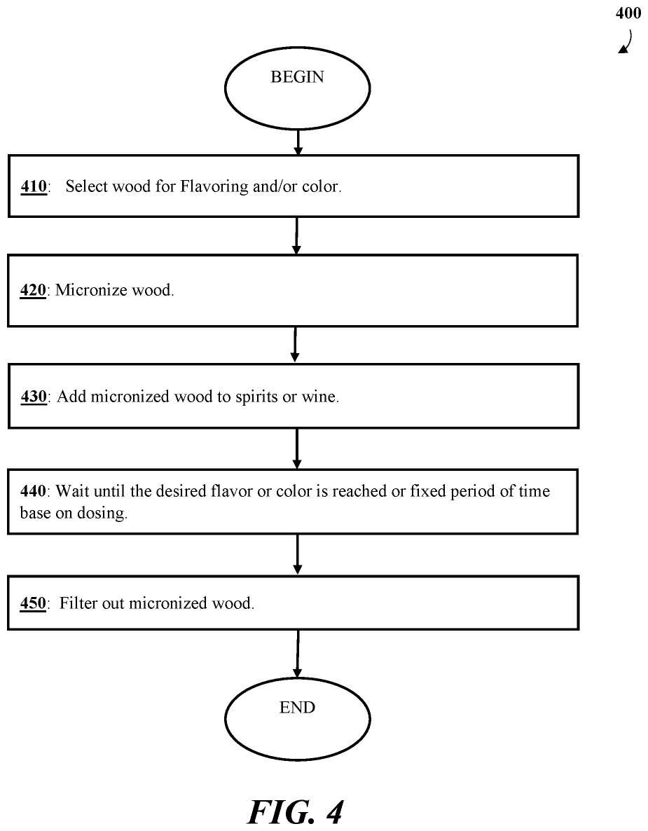

Referring to FIG. 4, is the process 400 for infusing a wine or spirits with flavors and color from micronized wood. This process could be applied to other plant materials where micronization provides a quick infusion of flavors or colors and better control what flavors are infused into a distillate. Examples of plant matter can include juniper berries for Gin, or spices.

In step 410, a wood or other plant matter is selected for micronization. This wood could be American Oak, French Oak, or another wood. The wood can be scraps or odd pieces of wood or even used barrels.

In step 420, the selected wood or plant matter can is micronized. The size of the wood for oak infusion is preferably between two and fifty microns. For other plant material, the micronization size may be larger or smaller.

In step 430, the micronized wood or other material is added to a distillate for infusion.

In step 440, the micronized wood or other product is maturated in the distillate for length of time. The length of time can be chosen from a table based on dosing, the micronized material, the size of the micronized material, the distillate characteristics, and a target flavor profile. In another embodiment, the length of time can depend on the testing of the maturating distillate. Testing can be based on color or the levels of one or more molecules or other chemistry of the maturation distillate.

In step 450, the micronized wood or other micronized material is filtered from the maturating distillate.

The corresponding structures, materials, acts, and equivalents of all means or step plus function elements in the claims below are intended to include any structure, material, or act for performing the function in combination with other claimed elements as specifically claimed. The description of the present technology has been presented for the purposes of illustration and description but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application and to enable others of ordinary skill in the art to understand the present technology for various embodiments with various modifications as are suited to the particular use contemplated.

Aspects of the present technology are described above with reference to flowchart illustrations and/or block diagrams of methods and apparatus (systems) according to embodiments of the present technology.

The flowchart and block diagrams in the Figures illustrate the architecture, functionality, and operation of possible implementations of systems, methods, and computer program products according to various embodiments of the present technology. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or combinations of special purpose hardware.

In the following description, for purposes of explanation and not limitation, specific details are set forth, such as particular embodiments, procedures, techniques, etc., in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment,” “in an embodiment,” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms, and a plural term may include its singular form. Similarly, a hyphenated term (e.g., “on-demand”) may occasionally be interchangeably used with its non-hyphenated version (e.g., “on-demand”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure.

The terminology used herein is for the purpose of describing particular embodiments only and is not intended to be limiting of the invention. As used herein, the singular forms “a,” “an,” and “the” are intended to include the plural forms as well unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

It is noted that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purposes only and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

While various embodiments have been described above, it should be understood that they have been presented by way of example only and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed:

1. A method of generating flavorings:
selecting one or more woods with desired profile;
selecting a micronization size;
micronizing the one or more selected woods so that substantially most of the one or more woods are broken at weak structural locations such as cell walls or other boundary areas.

2. The method of claim 1, wherein the micronization size is substantially between two to fifty microns.

3. The method of claim 2, wherein the micronizing the one or more woods is performed using Librixer comminutor method.

4. The method of claim 2, wherein the profile is a flavor profile.

5. The method of claim 2, wherein the profile is a color profile.

6. The method of claim 2, wherein the one or more woods is oak wood.

7. The method of claim 6, wherein the oak wood is toasted French oak.

8. A method of claim 1 further comprising adding the micronizied wood to a spirit or wine for a period of time.

9. A method of infusing flavor into a spirit or wine comprising:
selecting a quantity of one or more micronize wood products based on a target profile;
adding the selected micronized wood product to a quantity of spirits or wine;
wait an infusion time-period; and
filter the micronized one or more micronized wood product from the wine or spirit.

10. The method of claim 9, wherein the micronized wood product is substantially between two to fifty microns.

11. The method of claim 9, wherein the one or more wood product is micronized with a Librixer comminutor method.

12. The method of claim 9, wherein the profile is a flavor profile.

13. The method of claim 9, wherein the profile is a color profile.

14. The method of claim 9, wherein the one or more woods is oak wood.

15. The method of claim 9, wherein the infusion time-period is based on the quantity of the one or more micronized wood products, the quantity of spirits or wine, and an infusion time-table.

16. The method of claim 9, wherein the time-period is based on the measurement of one or more of color and volatiles.

17. The method of claim 16, wherein the one or more woods is oak wood.

18. A flavoring infusion product by formed by the process of micronization of one or more woods wherein the one or more woods is substantially broken at weak structural locations such as cell walls or other boundary areas.

19. The flavoring infusion product of claim 18, wherein the one or more woods is Oak and the infusion product is particles are Oak and between two and fifty microns in size.

20. The flavoring infusion product of claim 19, wherein the one or more woods is either American Oak or French Oak.
